(19) United States
(12) Patent Application Publication
(10) Pub. No.: US 2010/0120000 A1
(43) Pub. Date: May 13, 2010

(54) Method and Business Form for Employee Management and Improvement

(76) Inventors: Valorie Bellamy, Lawrenceville, GA (US); Monte Hytche, College Park, GA (US)

Correspondence Address: PHILIP H. BURRUS, IV, 460 Grant Street, Atlanta, GA, 30312, US

(21) Appl. No.: 12/268,480

(22) Filed: Nov. 11, 2008

(51) Int. Cl. G09B 19/00

(52) U.S. Cl. 434/109; 434/238; 434/107

(57) ABSTRACT

A method (200) for preparing a supervisor to manage an employee and for managing the employee includes the provision of a management scorecard document (400). The management scorecard document (400) can include a metric analysis portion (402), a behavior analysis portion (421), and a performance target section (434). The supervisor uses the management scorecard document (400) in a coaching session, such as a face-to-face meeting, to focus on developing employee behavior rather than simply delivering employee feedback.

### BACKGROUND

1. Technical Field

This invention relates generally to a method and business form facilitating management of employees, and more specifically to a method of preparing a supervisor, as well as providing the supervisor with appropriate tools, to empower the supervisor with practices and techniques for obtaining breakthrough performance from employees by utilizing a coaching model in the workplace.

2. Background Art

Countless volumes have been written on management techniques. Business schools offer numerous classes on “getting the most from your employees.” However, all to often, management of employees takes place at an arms-length distance. Supervisors are reluctant to truly get to “know” their employees. Employees are reluctant to share ideas with their supervisors. Quarterly or annual reviews are based on a check-list where each entry is limited to “completed” or “not completed.” Any one employee may have unlimited potential, but the realities of the workplace result in a supervisor that is unable to tap into that potential.

Truly inspiring supervisors and managers coach, mentor, and instill confidence in their reports. Average managers simply ensure that each employee does the minimum amount required. In short, good supervisors coach their employees, while average managers simply watch employees. By way of example, consider the difference between feedback, which is given by average managers, and coaching, which is provided by inspirational managers. When an employee is habitually fifteen minutes late, an average manager may provide feedback such as the following: “Bob, I notice you come in daily at 8:15. Our goal is to be here at 8. If you could go ahead and start getting here at 8, that would be super.” Contrastingly, an inspirational manager may coach the employee as follows: “Bob, I notice you're arriving about 15 minutes late. Let's work together on getting you here on time. For the next three days, record the precise time you leave the house, your travel time, and the time at which you arrive to work. I'll meet with you again in a week to discuss your findings and to see what we can do together to get you here a little earlier. Does that sound like it will help?”

The proverbial problem is just how to get managers and supervisors to be inspirational and not average. Businesses want managers to coach, not watch. Inspirational managers maximize productivity, increase efficiency, and have happier employees. Average managers are uninteresting and can be dreadful to work for.

There is thus a need for a method and tool that assists supervisors in coaching their employees and direct reports.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a table of behavioral analytics in accordance with embodiments of the invention.

FIG. 2 illustrates one method for preparing a supervisor to, and for carrying out, coaching of employees in accordance with embodiments of the invention.

FIG. 3 illustrates one method for preparing a supervisor to coach employees in accordance with embodiments of the invention.

FIGS. 4-6 illustrate one embodiment of a management scorecard document in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the present invention provide methods and tools to assist supervisors and managers at more effectively coaching their employees and reports. Embodiments of the invention assist supervisors in understanding the difference between feedback and coaching, and also provide supervisors with a coaching model with which they may coach their employees. Methods and tools described herein help supervisors find coaching opportunities and to establish defined performance outcomes. Using methods and tools described herein, supervisors are able to understand employee's styles and psychological needs, and to work with these traits in coaching sessions. Embodiments herein help supervisors define actions and obtain commitments from employees during coaching sessions as well.

Embodiments of the invention provide both a method of preparing a supervisor to coach an employee and a tool that the supervisor can use while coaching the employee. Once the tool is provided to the supervisor, the supervisor is taught to use it during the coaching session. For example, in one embodiment, the supervisor is provided with a management scorecard document. The management scorecard document includes a set of objective performance metrics corresponding to a position held by the employee. One example of a performance metric may be an average time to resolve customer inquiries, or an average customer service time spent on the telephone.

The management scorecard document also includes a set of behavioral analytics associated with the employee. These behavioral analytics can include both strengths and weaknesses associated with the employee. Each of the behavioral analytics can then be subdivided into a current assessment of a particular behavior, a business impact corresponding to the particular behavior, and a suggested modification of the particular behavior.

The management scorecard document then includes a set of improvement goals, which may be correlated with the overall business goals of the employer. In one embodiment, each of the improvement goals can also correspond to either the objective performance metrics or the behavioral analytics. The improvement goals can include both a current performance metric and a target metric, with the target metric represented as a goal agreed upon by employee and supervisor.

Once the supervisor has the tool, he schedules a face-to-face management session with the employee. In accordance with embodiments of the invention, coaching sessions occur face to face, in a comfortable environment. They generally do not transpire over the telephone or via e-mail.

During the coaching session, the supervisor discusses one or more of the objective performance metrics, the behavioral analytics, or the improvement goals with the employee. The supervisor, with the consult of the employee, documents numerical scores corresponding to at least one of the objective performance metrics on the management scorecard document, as well as documenting the suggested modification of the particular behavior. At the end of the coaching session, the manager documents at least one improvement goal on the management scorecard document and obtains written acceptance of the management scorecard document from the employee.

Embodiments of the present invention allow an employer to evaluate the supervisor's coaching performance and effectiveness with both quantitative agent-objective performance metrics and, in one embodiment, customer impact results. Although designed in one embodiment for the frontline supervisor, embodiments of the present invention can easily be modified to suit any participant charged with the responsibility of providing effective performance feedback in a timely manner. Metric methodology on the management scorecard document can also be tailored to any leadership role to establish a quantitative performance measurement.

Detailed descriptions of embodiments of the invention are now provided. For ease of illustration, an exemplary employee discussed herein will be a customer service representative who handles telephone calls from customers. It will be clear to those of ordinary skill in the art having the benefit of this disclosure that the invention is not so limited. Any number of types of employee may be substituted for the call service representative discussed herein.

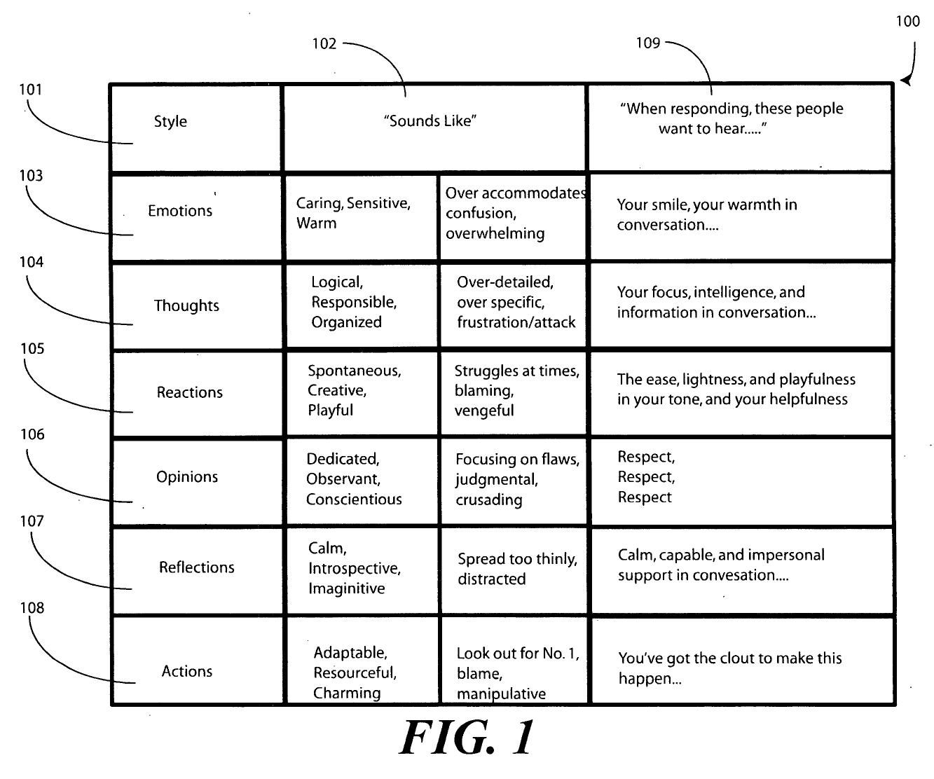

Some embodiments of the invention employ behavioral analytics in the coaching process. Turning now to FIG. 1, illustrated therein is an overview of examples of the behavioral analytics used by customer service representatives. These behavioral analytics are examples only, as others may be substituted or added without departing from the spirit and scope of the invention.

The table 100 in FIG. 1 illustrates styles 101 of behavioral analytics and perceptions 102 of how those behavioral analytics are received by employees or customers. Examples of styles 101 of behavioral analytics include emotions 103, thoughts 104, reactions 105, opinions 106, reflections 107, and actions 108. A person with an emotional style 103 may be that the person is caring, sensitive, and warm. However, a supervisor who is overly emotional may be perceived 102 as being over-accommodating, thereby confusing and overwhelming the employee.

A person with a thoughts-based personality style 104 may exhibit behavior that is logical, responsible, and organized. However, perceptions 102 of thoughts-based supervisor by employees may be that the supervisor is overly detailed oriented, which can be frustrating.

A person with a reactions-based personality style 105 may exhibit behavior that is spontaneous, creative, and playful. Perceptions 102 of reactions-based people may be that the person struggles with multiple conflicts. Further the person may blame others when solutions are not easily obtained.

A person with an opinions-based personality style 106 may exhibit behavior that is dedicated, observant, and conscientious. Sometimes, however, such a person may be perceived as focusing only on flaws and being judgmental.

A person with a reflections-based personality style 107 may exhibit behavior that is calm, introspective, and imaginative. One perception 102 that a reflections-based personality style 107 can give is that the person is distracted or spread too thinly.

A person with an actions-based personality style 108 may be resourceful and charming. However, such a person may be perceived as only looking out for himself. Some may even thing an actions-based style appears manipulative.

Column 109 provides examples of what some people who exhibit a corresponding behavioral style 101 wanting to hear in times of stress, such as performance reviews. These examples are of use to a supervisor who is a coach because the supervisor can integrate features of these responses into their coaching dialogue. They are also useful to an employee dealing with customers as customers with a specific personality style will may exhibit the same behavior when in distress. For example, an emotions-based person will respond positively to a smile and warmth. A thoughts-based person appreciates and requires focus, logic, and specific information. An opinions-based person is receptive to an expression of respect, professionalism, and authority. A reactions-based style person may desire ease, lightness, or playfulness in tone, as well as a helpful attitude. A reflections-based is receptive to calm, even tone of voice that is capable and supportive. An actions-based person may want to know that the supervisor has pull within the company to help the employee achieve his goals. By knowing the behavioral analytics set forth in table 101, the supervisor is able to become a better coach by identifying an employee's style or styles and accommodating those styles during the coaching process. Similarly, the employee is better able to assist customers by identifying the customer's style and accommodating that style during interactions with the customer.

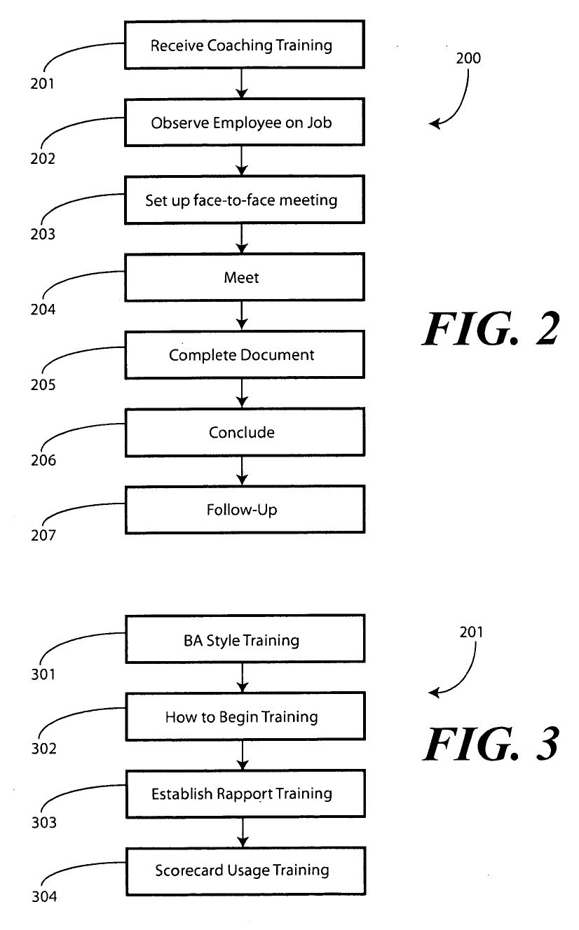

Turning now to FIG. 2, illustrated therein is one method 200 for conducting a performance review with an employee in accordance with embodiments of the invention. At step 201, the supervisor is trained with a coaching model that includes instructions on using the management scorecard document and the use of behavioral analytics.

Turning briefly to FIG. 3, illustrated therein is a detailed view of one embodiment of the training step 201, which prepares the supervisor to conduct the coaching process. At step 301, the supervisor is trained on behavioral analytics, such as those set forth in FIG. 1. The supervisor is first taught to think about past coaching sessions and how they were handled. After training on the behavioral analytic styles set forth in FIG. 1, the supervisor is then asked to consider how they may “redo” the coaching session for employees exhibiting certain behavioral analytics styles, such as emotions (103), thoughts (104), reactions (105), opinions (106), reflections (107), and actions (108).

At step 302, the supervisor is taught about how to begin a coaching session. This may include listening to the employee to determine which behavioral analytics styles they exhibit. This may also include the step of scheduling a face-to-face management session with the employee at least one week in advance. This may also include reserving a friendly and comfortable setting in which to hold the coaching session.

At step 303, the supervisor is taught to establish rapport with the employee. This can include location as did step 302. Specifically, the supervisor may be able to establish better rapport by obtaining a team room or other locale where the supervisor and employee can talk without interruption. Further, it may be a room where the supervisor and employee cannot be overheard by others. Rapport establishment can be enhanced with the use of a round table so as to avoid confrontational superior-subordinate configurations. Additionally, avoiding interruptions and having ready access to the management scorecard document (described below) is helpful as well.

In the rapport establishment step 303, the supervisor is taught to put the employee at ease prior to beginning the coaching process. The supervisor is taught to frame the discussion as a coaching session and not as a feedback session. The supervisor is taught to set the stage for an interactive discussion with the employee. The supervisor is taught to ensure that the session focuses on behavioral modifications that will improve performance rather than simple compliance with rules.

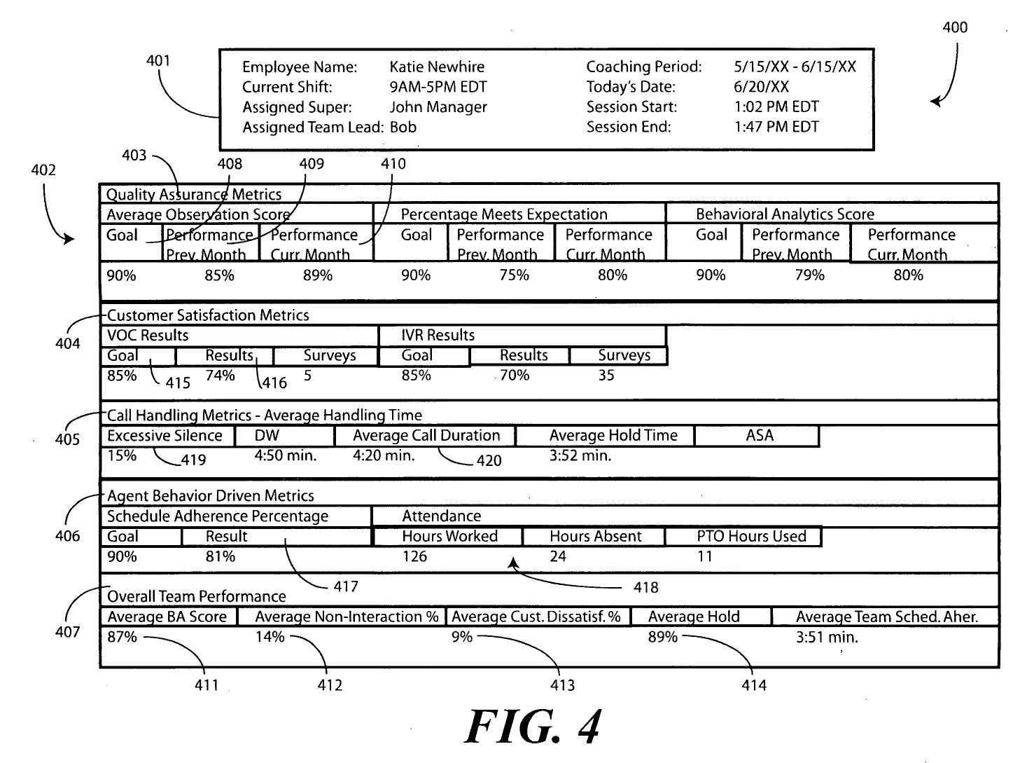

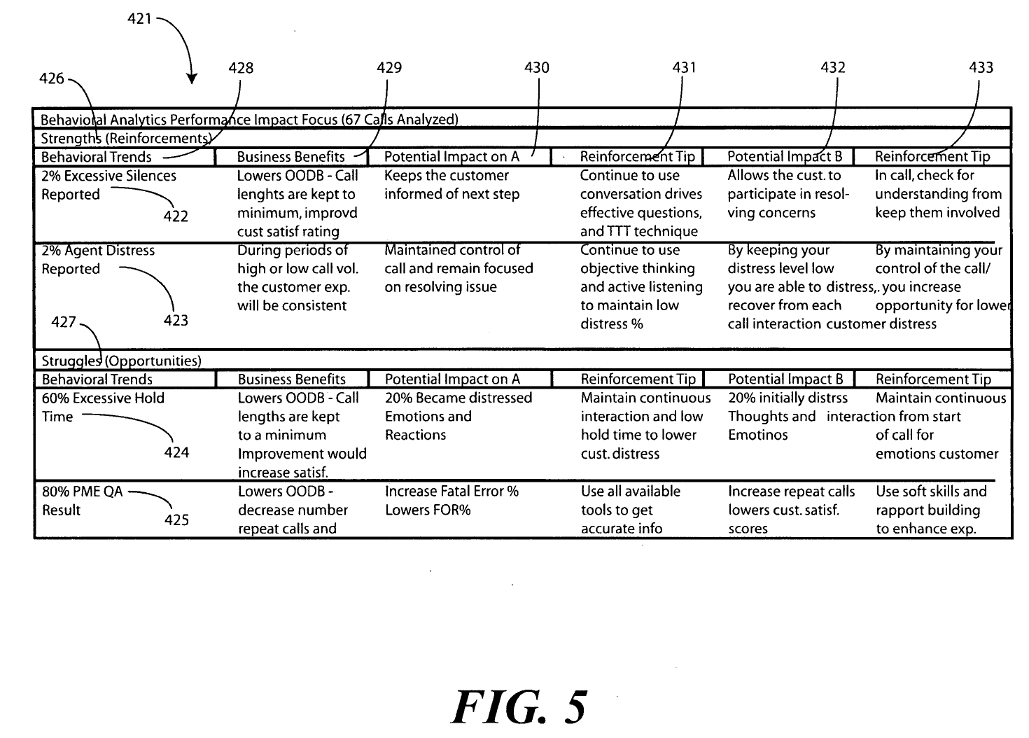

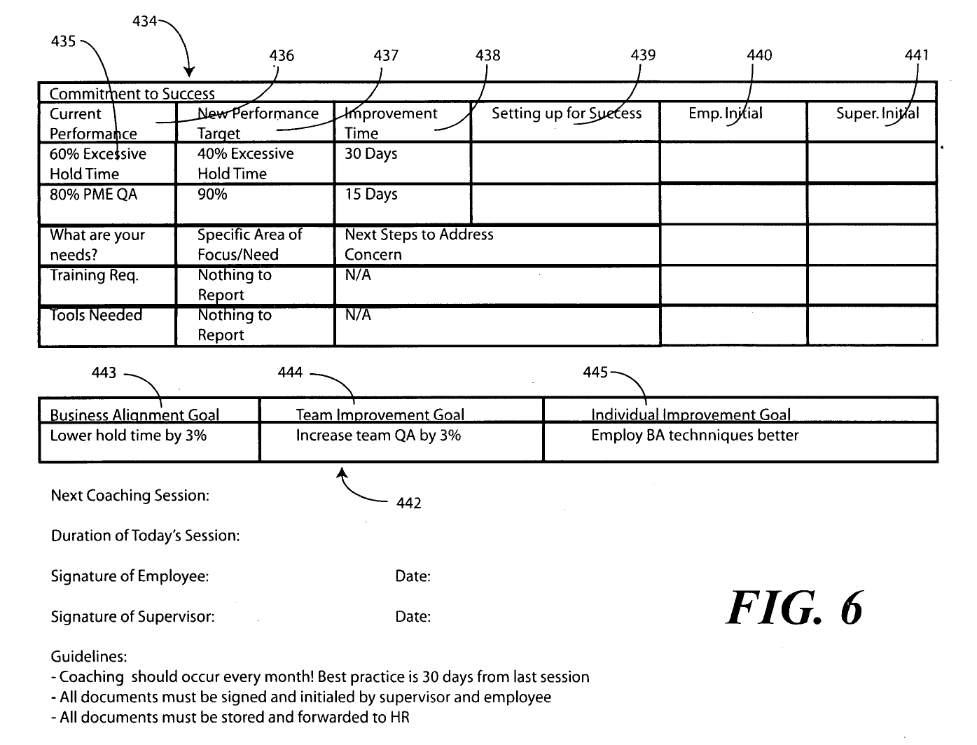

At step 304, the supervisor is taught to use the management scorecard document. Turning now to FIGS. 4-6 illustrated therein is one embodiment of a management scorecard document 400 in accordance with embodiments of the invention. FIGS. 4-6 may be separate pages of the management scorecard document 400. Alternatively, the management scorecard document 400 may be compressed to fit a single page.

The management scorecard document 400 begins with employee information 401, which can include employee name, shift, supervisor name, and coaching session date.

The management scorecard document 400 next includes a metric analysis portion 402. The metric analysis portion 402 includes predefined matrices for recording a plurality of objective performance metrics that correspond to a position held by the employee. In the illustrative customer service representative embodiment of FIG. 4, the objective performance metrics include a quality assurance metric 403, a customer satisfaction metric 404, a call handling metric 405, an employee behavior metric 406, and a team performance metric 407.

Each of these objective performance metrics can be arranged in a variety of ways. For instance, the quality insurance metric 403, in one embodiment, includes a target goal 408, a first employee performance measurement 409, which is an observation score corresponding to a predetermined amount of time under review (such as the previous month), and a comparison portion 410 for recording a grade stemming from the employee's performance during a present time of review or a comparison of the employee's performance against the target goal 408. Similarly, the team performance metric 407 may indicate a measurement 411 of a behavioral characteristic such as those found in FIG. 1—emotions, thoughts, reactions, opinions, and reflections.

Other measurements can be recorded in the metric analysis portion 402 as well. By way of example, the customer satisfaction metric 404 may include results taken from customer surveys regarding the employee's customer service. The customer satisfaction metric 404 can also include a customer service delivery metric desired result 415 and a customer service delivery metric achieved result 416. The employee behavior metric 406 can include a percentage of adherence by the employee to a predetermined goal 417 and an objective measurement 418 of employee behavior corresponding to the percentage adherence. The call handling metric 405, which is an example of a job specific metric, may include job specific information such as excessive silence 419, average duration time for each customer service call 420, and so forth.

In addition to the metric analysis portion 402, in one embodiment the management scorecard document 400 includes a behavior analysis portion 421. The behavior analysis portion 421 includes predefined matrices for recording a plurality of behavioral analytics corresponding to the employee. In one embodiment, the plurality of behavioral analytics is divided into strength analytics 426 and weakness analytics 427. Each of the plurality of behavioral analytics includes at least a current assessment of a particular behavior, a business impact corresponding to the particular behavior, and a suggested modification of the particular behavior.

Illustrating by example, the plurality of behavioral analytics in FIGS. 4-6 include an excessive silence analytic 422, an agent distress analytic 423, an excessive hold time analytic 424, and resolution analytic 425. Each analytic includes a current assessment of employee behavior. This is represented in FIGS. 4-6 as a behavioral trend exhibited by the employee 428 and a business impact or benefit section 429 illustrating how the behavioral trend affects business performance. The behavioral trend can include indicia of performance relating to a customer service characteristic, such as excessive silence from a customer service representative.

Each analytic may then include a plurality of potential or illustrative employee behaviors 430,432 and how each might impact a customer having a particular behavioral analytic style. The analytics can then include a suggested modification 431,433 to the particular behavior. The suggested modifications 431,433, which may be configured as cells to be filled in for documentation during the coaching session, in one embodiment are for recording at least two reinforcement tips corresponding to the two potential or illustrative employee behaviors 430,432.

The management scorecard document 400 then includes a performance target section 434 that includes a plurality of improvement goals corresponding to at least one of the plurality of objective performance metrics or the plurality of behavioral analytics. The performance target section 434 serves as a future success portion, in that it lists goals and steps for the employee to achieve to become more successful. In the illustrative embodiment of FIGS. 4-6, the performance target section 434 includes as one improvement goal excessive hold time 435. A current performance metric 436 is provided, as is a new target performance metric 437. A time 438 for achieving the new target metric is given, as is space 439 for listing tools or other needs for achieving the new goal. The supervisor and employee may record acceptance of these new goals with signature or initial blocks 440,441.

The management scorecard document 400 may additionally include a goal portion 442 that includes a business alignment portion 443, a team improvement portion 444, and an individual improvement portion 445. The business alignment portion 443 is for recording a business alignment goal. The team improvement portion 444 is for recording a team improvement goal. The individual improvement portion 445 is for recording an individual improvement goal.

Turning now back to FIG. 2, once the supervisor has received coaching training at step 201, the supervisor may need to observe the employee performing a job at step 202. For example, using the illustrative customer service representative as an example, the supervisor may want to listen to excerpts from customer service calls so that some of the measured information on the management scorecard document (400) can be filled in prior to the coaching session. Once data relating to the employee's performance is obtained, the supervisor may populate the data in the management scorecard document (400). For instance, the supervisor may fill in data corresponding to the predetermined amount of past time under review, such as the previous month discussed in FIGS. 4-6.

At step 203, the supervisor is instructed to, and does, set up a face-to-face meeting with the employee. In one embodiment, this face-to-face meeting is scheduled at least a week in advance, thereby giving the employee and supervisor sufficient time to prepare for a coaching session. During this preliminary time, the supervisor may define desired outcomes from the coaching session. The supervisor may plan demonstrations of desired approaches for future employee behavior.

At step 204, the supervisor meets with the employee. During the coaching session, the supervisor ensures that the session focuses on behavioral modifications that will improve the employee performance. The supervisor maintains a calm demeanor at all times, and avoids any defensive or distress behaviors. The supervisor works to deliver coaching in a manner compatible with the employee's behavioral analytic style. The supervisor emphasizes good points with the same vigor as deficient points. The supervisor ensures that the employee understands the importance of a particular behavior on the customer experience.

During the meeting, the supervisor and employee complete the management scorecard document (400). This can include discussing one or more of the plurality of objective performance metrics, the plurality of behavioral analytics, or the plurality of improvement goals with the employee. This also includes documenting numerical scores corresponding to at least one of the plurality of objective performance metrics on the management scorecard document, documenting the suggested modification of the particular behavior on the management scorecard document, and documenting at least one improvement goal on the management scorecard document.

Documentation can further include defining goals and action plans, which are then recorded on the management scorecard document (400). These goals should be specific and measurable. They should also be positive and “result oriented” rather than “attempt oriented.” Further, the goals should have a reasonable chance of being achieved. The supervisor then obtains the commitment of the employee on the management scorecard document (400). Once the management scorecard document (400) is complete, the supervisor obtains written acceptance of the employee on the management scorecard document.

The step 205 of completing the management scorecard document (400) can include identifying goals for the employee. For instance, the supervisor may identify an opportunity of the employee and record it in the performance target section (434) of the management scorecard document (400). This can be accomplished, in some instances, by comparing the target goal and the observed score and recording an improvement target in the performance target section (434). It may also include documenting reinforcement tips for particular illustrative behaviors in the behavior analysis portion (421).

Once this is complete, in one embodiment the supervisor then assess the coaching situation's progress. The supervisor may review actions and progress from previous coaching sessions. The supervisor may take additional steps to reinforce positive behaviors and to identify areas of opportunity. The supervisor may brainstorm with the employee to identify other areas of opportunity for improvement. The supervisor may summarize the coaching session to ensure clarity and focus. The supervisor may demonstrate just why a particular area of opportunity is an opportunity for improvement. The supervisor then concludes the coaching session at step 206.

After concluding the coaching session, the supervisor follows-up with the employee at step 207. During the follow-up, the supervisor works to ensure that the employee is actually modifying his behavior based upon information exchanged in the coaching session and documented on the management scorecard document (400). Supervisors keep track of action items and goals established during the coaching session by way of the management scorecard document (400). They follow up with employees when the action items are due. They consistently review how the employee has incorporated the recommended changes in their day to day work. They establish timelines for changes that have not been incorporated. They also set expectations for timelines for future coaching sessions.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method of managing an employee, the method comprising the steps of:
providing a management scorecard document comprising:
a plurality of objective performance metrics corresponding to a position held by the employee;
a plurality of behavioral analytics corresponding to the employee, the plurality of behavioral analytics comprising at least one strength analytic and at least one weakness analytic, wherein each of the plurality of behavioral analytics comprises at least a current assessment of a particular behavior, a business impact corresponding to the particular behavior, and a suggested modification of the particular behavior; and
a plurality of improvement goals, each of the plurality of improvement goals corresponding to at least one of the plurality of objective performance metrics or the plurality of behavioral analytics, wherein each of the plurality of improvement goals comprises a current performance metric and a target metric;
scheduling a face-to-face management session with the employee;
meeting with the employee;
discussing one or more of the plurality of objective performance metrics, the plurality of behavioral analytics, or the plurality of improvement goals with the employee;
documenting numerical scores corresponding to at least one of the plurality of objective performance metrics on the management scorecard document;
documenting the suggested modification of the particular behavior on the management scorecard document; and
documenting at least one improvement goal on the management scorecard document; and
obtaining written acceptance of the employee on the management scorecard document.

2. The method of claim 1, wherein at least one of the plurality of objective performance metrics comprises a quality assurance metric comprising an target goal, and an observation score, further comprising the step of identifying an opportunity for improvement for the employee by comparing the target goal and the observation score, wherein the step of documenting numerical scores comprises recording an improvement target on the management scorecard document.

3. The method of claim 2, wherein at least one of the plurality of objective performance metrics comprises a customer satisfaction metric.

4. The method of claim 3, wherein at least one of the plurality of objective performance metrics comprises a team performance metric comprising a measurement of a behavioral characteristic selected from the group consisting of emotions, thoughts, reactions, opinions, and reflections.

5. The method of claim 1, wherein the current assessment of the particular behavior comprises a behavioral trend, wherein the behavioral trend comprises an indicia of performance relating to a customer service characteristic, wherein the plurality of behavioral analytics further comprises a plurality of potential employee behaviors, and wherein the step of documenting the suggested modification comprises documenting a plurality of reinforcement tips on the management scorecard document.

6. The method of claim 1, wherein the step of scheduling comprises scheduling at least one week in advance.

7. A management scorecard document configured to assist a supervisor in managing an employee, the management scorecard document comprising:
a metric analysis portion, the metric analysis portion comprising predefined matrices for recording a plurality of objective performance metrics corresponding to a position held by the employee;
a behavior analysis portion, the behavior analysis portion comprising predefined matrices for recording a plurality of behavioral analytics corresponding to the employee, the plurality of behavioral analytics comprising at least one strength analytic and at least one weakness analytic, wherein each of the plurality of behavioral analytics comprises at least a current assessment of a particular behavior, a business impact corresponding to the particular behavior, and a suggested modification of the particular behavior; and
a performance target section, the performance target section comprising a plurality of improvement goals, each of the plurality of improvement goals corresponding to at least one of the plurality of objective performance metrics or the plurality of behavioral analytics, wherein each of the plurality of improvement goals comprises a current performance metric and a target metric.

8. The management scorecard document of claim 7, wherein the plurality of objective performance metrics comprise at least a quality assurance metric, a customer satisfaction metric, and an employee behavior metric.

9. The management scorecard document of claim 8, wherein the quality assurance metric comprises at least a goal, a first employee performance measurement corresponding to a predetermined amount of past time and a second employee performance measurement corresponding to a predetermined amount of time under review, wherein the metric analysis portion further comprises a comparison portion for recording a grade stemming from a comparison of the first employee performance measurement with the second employee performance measurement.

10. The management scorecard document of claim 8, wherein the customer satisfaction metric comprises a customer service delivery metric desired result and a customer service delivery metric achieved result.

11. The management scorecard document of claim 8, wherein the employee behavior metric comprises a percentage of adherence by the employee to a predetermined goal and an objective measurement of employee behavior corresponding to the percentage of adherence.

12. The management scorecard document of claim 8, wherein the plurality of objective performance metrics further comprises a job specific metric corresponding to the position.

13. The management scorecard document of claim 12, wherein the position is a customer service representative, wherein the job specific metric comprises an average time for each customer service call.

14. The management scorecard document of claim 7, wherein the current assessment of the particular behavior comprises a behavioral trend exhibited by the employee.

15. The management scorecard document of claim 14, wherein the behavior analysis portion comprises a illustrative behavior portion configured for recording at least two illustrative behaviors, wherein the suggested modification of the particular behavior comprises at least two reinforcement tips corresponding to the at least two illustrative behaviors.

16. The management scorecard document of claim 7, further comprising a future success portion, the future success portion comprising a predefined matrix for recording an indicia of current performance, an indicia of target performance, and a time for achieving the indicia of target performance.

17. The management scorecard document of claim 16, wherein the future success portion further comprises cells for recording acceptance by the employee and acceptance by the supervisor.

18. The management scorecard document of claim 7, further comprising a goal portion comprising a business alignment portion for recording a business alignment goal, a team improvement portion for recording a team improvement goal, and an individual improvement portion for recording an individual improvement goal.

19. A method of preparing a supervisor to conduct a performance review with an employee, the method comprising the steps of:
obtaining employee performance data by observing the employee performing a job;
providing a management scorecard document comprising:
a plurality of objective performance metrics corresponding to a position held by the employee, the plurality of objective performance metrics comprising at least a quality assurance metric comprising at least a goal, a first employee performance measurement corresponding to a predetermined amount of past time and a second employee performance measurement corresponding to a predetermined amount of time under review, wherein the plurality of objective performance metrics further comprises a comparison portion for recording a grade stemming from a comparison of the first employee performance measurement with the second employee performance measurement;
a plurality of behavioral analytics corresponding to the employee, the plurality of behavioral analytics comprising at least one strength analytic and at least one weakness analytic, wherein each of the plurality of behavioral analytics comprises at least a current assessment of a particular behavior, a business impact corresponding to the particular behavior, and a suggested modification of the particular behavior; and
a plurality of improvement goals, each of the plurality of improvement goals corresponding to at least one of the plurality of objective performance metrics or the plurality of behavioral analytics, wherein each of the plurality of improvement goals comprises a current performance metric and a target metric;
populating the first employee performance measurement corresponding to the predetermined amount of past time and the second employee performance measurement corresponding to the predetermined amount of time under review with at least a portion of the employee performance data;
instructing the supervisor to schedule a face-to-face management session with the employee;
instructing the supervisor to complete the management scorecard document during the face-to-face management session; and
receiving a completed management scorecard document from the supervisor.

20. The method of claim 19, further comprising the step of requiring the supervisor to attend training regarding completion of the management scorecard document prior to the step of instructing the supervisor to schedule the face-to-face management session with the employee.
